(19) United States
(12) Patent Application Publication
(10) Pub. No.: US 2022/0143800 A1
(43) Pub. Date: May 12, 2022

(54) Apparatus Comprising A Plurality Of Different Tools

(71) Applicant: Douglas Alexander Windeler, Stroud (GB)

(72) Inventor: Douglas Alexander Windeler, Stroud (GB)

(21) Appl. No.: 17/435,182

(22) PCT Filed: Mar. 2, 2020
(86) PCT No.: PCT/GB2020/000026

§ 371 Date: Aug. 31, 2021

(30) Foreign Application Priority Data
Mar. 5, 2019 (GB) 1902972.7

(51) Int. Cl. B25F 1/04

(52) U.S. Cl. CPC B25F 1/04

(57) ABSTRACT

Apparatus (2) comprising a plurality of different tools (4), and the tools (4) being such that: (i) each tool (4) comprises a functional portion (6) configured for performing a task, and a mounting portion (8) by which the tool (4) is mounted to the apparatus (2); (ii) the functional portions (6) of the tools (4) are different for performing different tasks, (iii) the tools (4) are rotatable relative to one another such that the tools (4) are able to be aligned with their functional portions (6) adjacent each other and pointing in the same direction; (iv) the tools (4) are usable in the apparatus (2) by rotating a required one of the tools (4) out of alignment with the other tools (4); (v) the tools (4) are separable from the apparatus (2); and (vi) the tools (4) are constructed for use as stand-alone tools whereby, when the tools (4) are removed from the apparatus (2) they are able to be used to perform their intended task without having to be connected to other tool parts.

This invention relates to apparatus comprising a plurality of different tools.

Apparatus comprising a plurality of different tools is well known. Typically the apparatus comprises a number of different tools which are arranged side by side in a housing. The tools pivot about shafts provided at each end of the housing. In a non-use position, the tools are in the housing. When a particular tool is required, it is pivoted about its shaft out of the housing for use. Typical of such tools is that known as a Swiss army knife.

The known apparatus suffers from a problem in that the tools are fixed in position on their shafts. When a tool is pivoted to its use position, the other tools may impede the easy use of the required tool. Also, many of the tools provided on the apparatus are never normally required by the user. This is even so if the apparatus is produced for a particular area of activity, for example for cyclists, surfers or survival experts, rather than being produced just for general use.

It is an aim of the present invention to reduce the above mentioned problems.

Accordingly, in one non-limiting embodiment of the present invention there is provided apparatus comprising a plurality of different tools, and the tools being such that:
(i) each tool comprises a functional portion configured for performing a task, and a mounting portion by which the tool is mounted to the apparatus;
(ii) the functional portions of the tools are different for performing different tasks;
(iii) the tools are rotatable relative to one another such that the tools are able to be aligned with their functional portions adjacent each other and pointing in the same direction;
(iv) the tools are usable in the apparatus by rotating a required one of the tools out of alignment with the other tools;
(v) the tools are separable from the apparatus; and
(vi) the tools are constructed for use as stand-alone tools whereby, when the tools are removed from the apparatus, they are able to be used to perform their intended task without having to be connected to other tool parts.

The apparatus of the present invention is advantageous because the tools are constructed as stand-alone tools. Thus, there is no need to connect the tools to other tool parts in order to enable them to be used. For example, there is no need for the tools to have to be connected to a commonly usable handle before they can be used, as occurs in the case of some known tools. If desired, the tools can be rotated to a use position and used whilst still being on the apparatus. The user thus has two possibilities of how to use the tools of the apparatus of the present invention.

The apparatus of the present invention may be constructed in the form of a hand-holdable piece of apparatus. The apparatus may be the general size and form of known pieces of apparatus such for example as those having folding tools and known generally as a Swiss army knife. The apparatus may however be made in any desired shape and size, with the shape and/or size being as required for the tools and their intended area of use.

The apparatus of the present invention may allow a user to have the tools in any order and in any number as may be required by the user.

The apparatus may be one in which the mounting portions are of the same shape and size, and located in the same relative position on each tool. This enables the apparatus to be constructed in a neat ergonomic shape and without unnecessary projecting portions.

The apparatus may be one in which the tools are held together by magnetism, and in which the tools are separable from the apparatus by being slid from the apparatus against the magnetism. The holding of the tools together by magnetism is advantageous in that the tools are not held together by one or more shafts about which the tools pivot, as in the case of known apparatus. With the tools being held together by magnetism, they are easily removed from the apparatus, and they are able to be used on their own and without having their use impeded by the remainder of the apparatus.

The apparatus may be one in which each tool comprises a mounting magnet which enables the tools to be held together by the magnetism.

The mounting magnet may be embedded in the tool such as not to increase the thickness of the tool. This enables the overall thickness of the tool to be kept to a minimum, which in turn helps to minimise the overall thickness of the apparatus. The mounting magnet may be embedded in the tool such as to finish flush with at least one of the sides of the tool. Preferably the mounting magnet is positioned in the mounting portion of the tool. The mounting magnet may however be positioned elsewhere if desired.

The apparatus may be one in which the tools are made of a non-magnetic material, and in which the mounting magnet is provided in the non-magnetic material. The non-magnetic material may be an austenitic metal. The austenitic metal is preferably titanium or stainless steel but other austenitic metals may be employed. Other non-magnetic materials may be employed including, for example, carbon fibre and plastics materials.

The mounting magnet is preferably a neodymium magnet. Other types of mounting magnets may be employed. Generally, the mounting magnet will be one which is sufficiently powerful to retain the different tools together side by side, whilst enabling them to be slid apart for use.

The apparatus may be one in which the mounting magnet also provides the aligning.

The apparatus of the present invention may alternatively be one in which the tools are held together by mechanical holding means. The mechanical holding means may be, for example, a snap fit mechanical holding means, a press fit mechanical holding means, or a push fit mechanical holding means. Other types of mechanical holding means may be employed, for example any suitable mechanical holding means that has an annular ridge which extends into a groove for holding purposes. Similarly to the case of the tools being held together by magnetism, when the tools are held together by the mechanical holding means, they are not held together by one or more shafts about which the tools pivot, as in the case of known apparatus. The tools are thus easily removed from the apparatus, and they are able to be used on their own and without having their use impeded by the remainder of the apparatus. This advantage may be a feature of all designs of the apparatus of the present invention.

The apparatus may include aligning means for providing the aligning.

The aligning means may be an aligning magnet. The aligning magnet may be embedded in the tools such as not to increase the thickness of the tool. The aligning magnet may be embedded in the tool such as to finish flush with at least one of the sides of the tool. Typically, the aligning magnet will be positioned in the functional portion of the tool. The aligning magnet may however be positioned in another part of the tool if required.

Alternatively, the aligning means may be a mechanical aligning means. The mechanical aligning means may be a ball and detent arrangement. Other types of mechanical aligning means may be employed.

The mechanical alignment means may be on the mounting portion of the tool. The mechanical aligning means may be positioned elsewhere on the tool if desired.

Advantageously, the tools are configured with flat sides for enabling the tools to be as thin as possible, and thereby to minimise on the overall thickness of the apparatus.

The apparatus may be one in which the mounting portions are each provided with a mounting aperture for receiving mounting means for use in mounting the apparatus. The mounting aperture may thus be used for receiving a lanyard by which the apparatus may be hung, for example from a bracket in a garage or from a belt or work pouch of a user. Alternatively, the mounting aperture may be for receiving a nail or a hook on a wall.

The apparatus may include the mounting means. The mounting means may be the lanyard. Other types of mounting means may be employed.

The apparatus may include a cover for the apparatus. Preferably the cover is a non-magnetic cover. Such a cover may help to avoid the apparatus attracting metal debris due to the magnetism.

The apparatus may include a holder for holding the apparatus on a wall with the tools being separated from each other, the holder being formed of a material which enables the tools to adhere to the holder by magnetism. The holder may be a metal strip or a metal plate. The metal plate may be rectangular, square or of any other desired shape. The metal strip and the metal plate may be magnetic, or they may be of a ferrous material to which the tools are able to adhere by magnetism.

The apparatus may include at least one tool body, wherein the tool body comprises a first end by which the tool body is mounted to the apparatus and a second end which is configured for releasably receiving a tool head for performing a task, whereby the second end is able to receive different tool heads for performing different tasks.

The first end of the tool body may be of the same shape as the mounting portion of each one of the tools comprising the functional portion and the mounting portion. Other shapes for the first end of the tool body may be employed. The second end of the tool body may comprise any suitable releasable fastener means. The fastener means may thus be, for example, a receiving slot and a holding magnet, or a press fit. The tool body may be used for receiving a plurality of tool heads which all have the same general function. Thus, for example, the plurality of different heads may all be different types of screwdriver heads so that the different heads may be Allen key heads, hex heads, flat heads or Posidrive heads. The facility to use the different tool heads may be advantageous where tools are required having a hard tip which is harder than normal. In this case, the tool heads can all be made of the material giving the required hardness, and only one tool body will be required. This tool body can be made of the same material as the tool heads or it can be made of a softer material.

Embodiments of the invention will be now be described solely by way of example and with reference to the accompanying drawings in which:

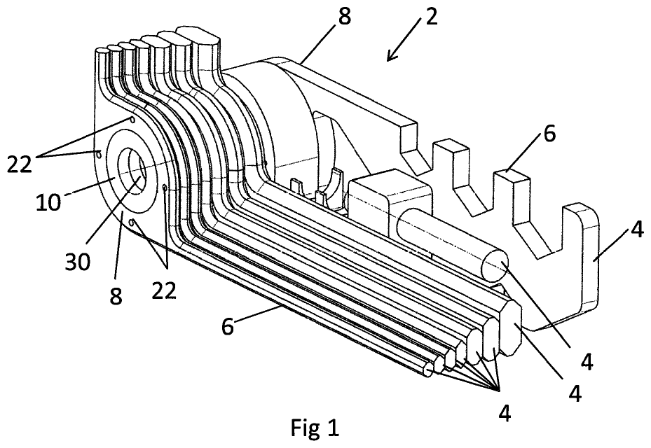

FIG. 1 is a perspective view from the front and one side of apparatus of the present invention with its tools in a closed aligned position;

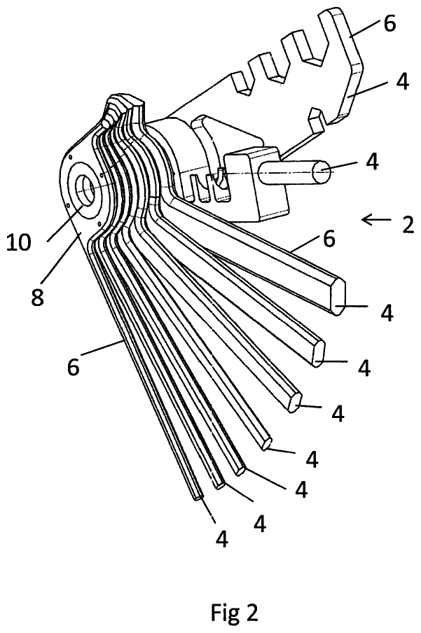

FIG. 2 is a view like FIG. 1 but shows the tools rotated out of alignment so that the tools can be seen;

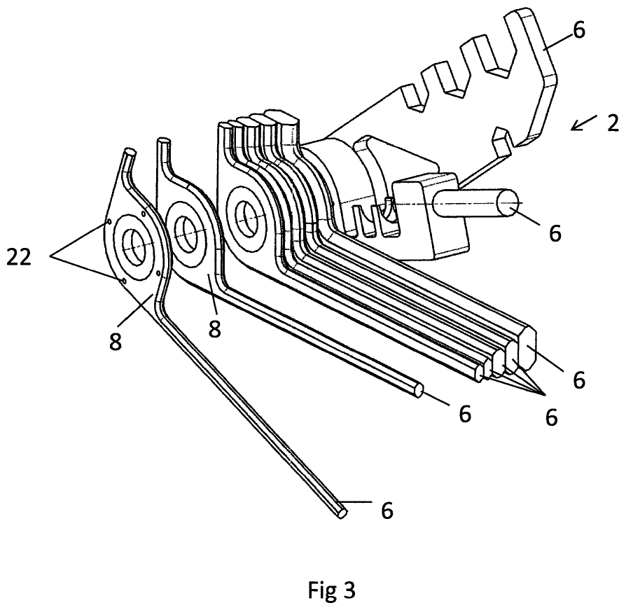

FIG. 3 is a view like FIG. 1 but shows some of the tools separated from each other;

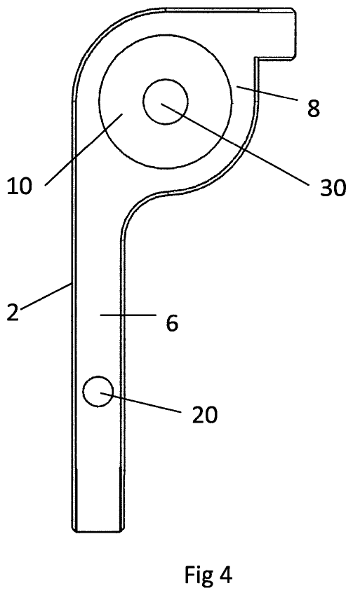

FIG. 4 is a side view of a preferred configuration of a tool;

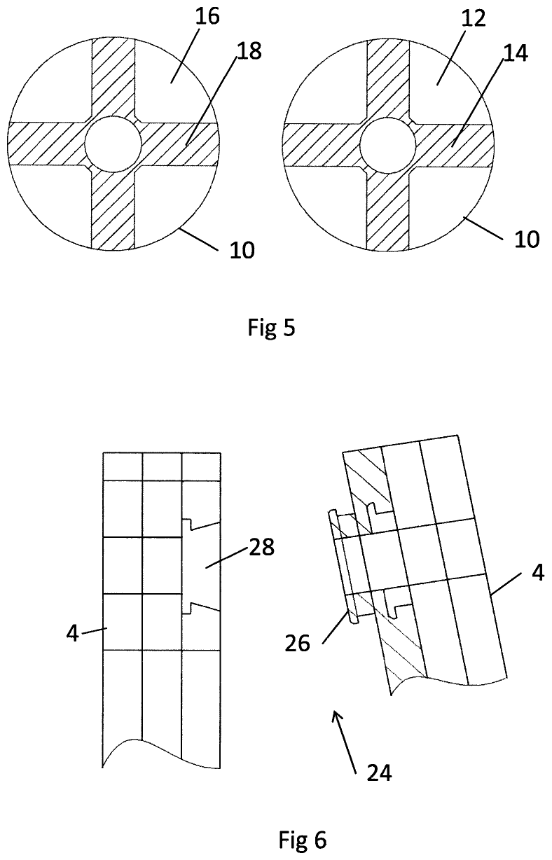

FIG. 5 illustrates how the poles of two magnets can be arranged to provide magnetism and alignment;

FIG. 6 is a cross-section through part of two tools with the apparatus of the present invention showing mechanical aligning;

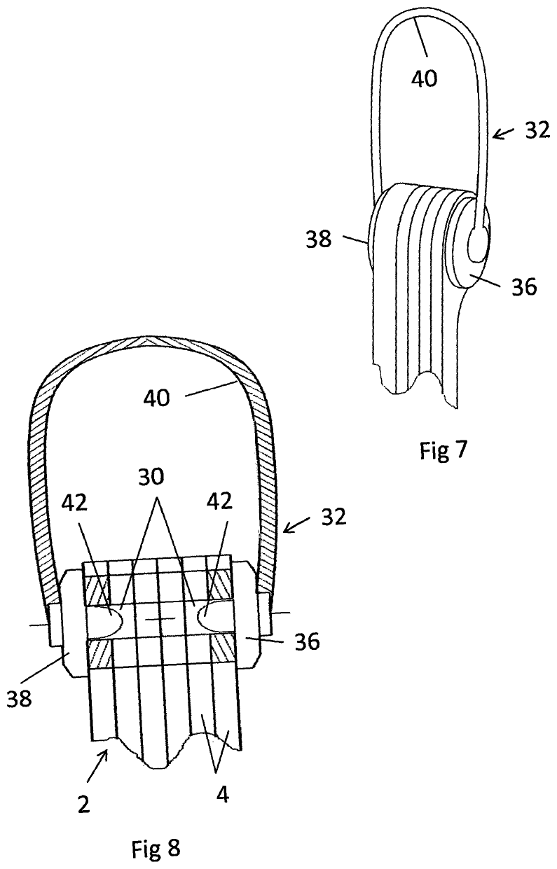

FIG. 7 is a perspective view showing apparatus of the present invention provided with mounting means in the form of a lanyard;

FIG. 8 is a cross-sectional view through part of the apparatus shown in FIG. 7;

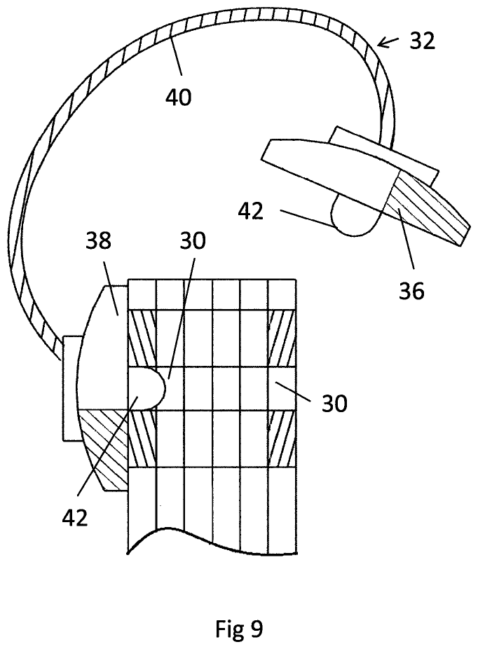

FIG. 9 is a view like FIG. 8 and shows how the lanyard can be removed from the remainder of the apparatus of the invention;

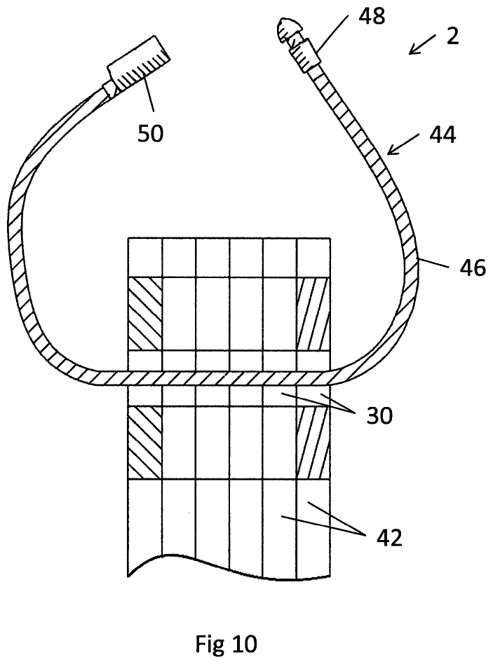

FIG. 10 shows apparatus of the present invention comprising an alternative type of lanyard;

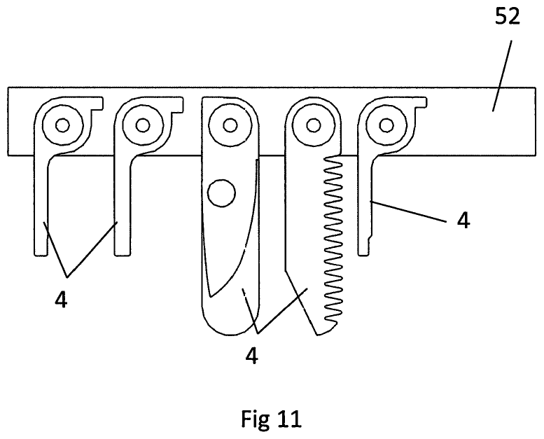

FIG. 11 shows the tools of apparatus of the present invention in a separate form and stuck onto a rectangular magnetic holder;

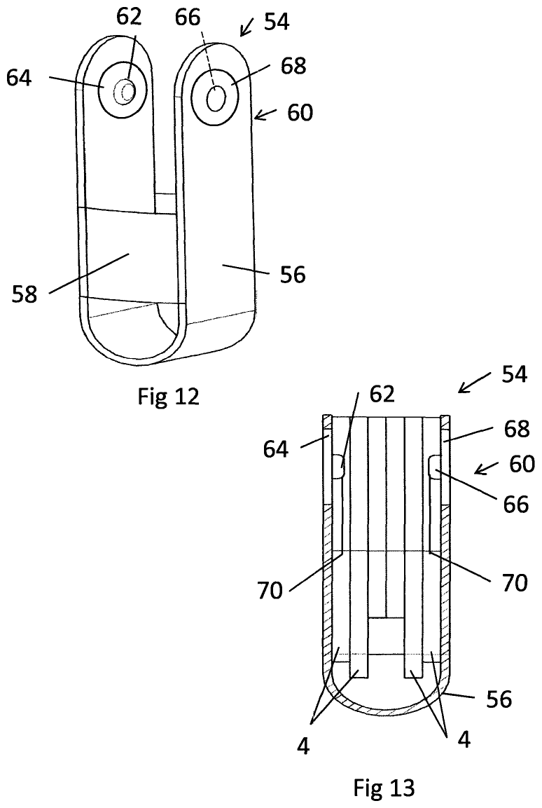

FIG. 12 is a perspective view of a case which may be for the apparatus of the present invention; and

FIG. 13 is a section through the case as shown in FIG. 12.

Referring to FIGS. 1-3, there is shown apparatus 2 comprising a plurality of different tools 4. For ease of illustration, some of the tools 4 have been shown as being of a similar shape but of different thicknesses and without specific tool shape.

The tools 4 are such that each tool comprises a functional portion 6 which is configured for performing a task, and a mounting portion 8 by which the tool 4 is mounted to the apparatus 2. The functional portions 6 of the tools 4 are different for performing different tasks.

The tools 4 are rotatable relative to one another such that the tools 4 are able to be aligned with their functional portions adjacent each other and pointing in the same direction. The alignment of the tools is shown in FIG. 1.

The tools 4 are usable in the apparatus 2 by rotating a required one of the tools 4 out of alignment with the other tools 4. This can be appreciated from FIG. 2 where the tools 4 are shown out of alignment. For use, only one of the tools 4 would normally be rotated out of alignment at a time in order to enable the particular task required by the tool 4 to be conducted.

The tools 4 are held together by magnetism. As can best be appreciated from FIG. 3, the tools 4 are separable from the apparatus 2 by being slid from the apparatus 2 against the magnetism. The tools 4 are not mounted for rotation or pivoting on a shaft.

As can best be appreciated from FIGS. 1, 2 and 3, the tools are constructed for use as stand-alone tools 4 whereby, when the tools 4 are removed from the apparatus 2, they are able to be used to perform their intended task without having to be connected to other tool parts. The mounting portion 8 acts as a handle for its tool 4. The functional portion 6 is appropriately constructed for the task in hand, for example a knife blade or various types of screwdriver, or a bradawl. The precise construction of the tools will depend upon the industry for which the apparatus 2 is created. Thus, for example, the apparatus 2 may be constructed for workmen such for example as carpenters, DIY enthusiasts, or plumbers. Alternatively, the apparatus 2 may be constructed for leisure industries, for example for cyclists, surfers, campers or persons enjoying survival pursuits.

The tools 4 each comprises a mounting magnet 10 which enables the tools 4 to be held together by the magnetism. The mounting magnet 10 is embedded in the tool 4 such as not to increase the thickness of the tool 4. More specifically, the mounting magnet 10 is embedded in the tool 4 such that it finishes flush with both sides of the tool 4. The mounting magnet 10 is positioned in the mounting portion of the tool 4.

The tools 4 are made of a non-magnetic material such for example as an austenitic metal. A preferred austenitic metal is stainless steel. Other non- magnetic materials may be employed such for example as carbon fibre and plastics materials. The mounting magnet 10 is provided in the non-magnetic material. A preferred mounting magnet 10 is a neodymium magnet 10. Other types of magnets may be employed.

The mounting magnet 10 may also be such that it provides the aligning. This may be arranged by having mounting magnets 10 with appropriate north and south poles 12, 14 respectively providing forces 16, 18 respectively as shown in FIG. 5.

Alternatively, the apparatus 2 may comprise aligning means in the form of an aligning magnet 20 for providing the aligning. Such aligning means are shown in FIG. 4. It will be seen that the aligning magnet 20 is embedded in the tool 2 such as not to increase the thickness of the tool 2. The aligning magnet 20 is embedded in the tool 2 such as to finish flush with the sides of the tool 2. As shown, the aligning magnet 20 is positioned in the functional portion 6 of the tool 2.

Alternatively, if desired, the aligning means may be a mechanical aligning means. One mechanical aligning means is a ball and detent arrangement 22 as shown in FIG. 1. Such a mechanical aligning means is positioned in the functional portion 6 of the tool 4. An alternative mechanical aligning means 24 is shown in FIG. 6. In the mechanical aligning means 24 shown in FIG. 6, a button member 26 locates in a recess 28.

As can be appreciated from FIGS. 1-4, the tools 4 are constructed to be as thin as possible. This thereby minimises on the overall thickness of the apparatus 2. The tools 4 are constructed to be thin.

The apparatus 2 may be such that the mounting portions 8 on the tools 4 are each provided with a mounting aperture 30 for receiving mounting means such for example as a lanyard 32 shown in FIGS. 7-9. The lanyard 32 comprises locating members 36, 38 for fitting in opposed mounting apertures 30 in opposite sides of the apparatus 2. The locating members 36, 38 are provided at each end of a lanyard strip 40. The locating members 36, 38 may be made of a magnetic material for facilitating their quick insertion and release into the mounting apertures 30. Alternatively, the locating members 36, 38 may be made of a non-magnetic material, whereby the locating members 36, 38 are simply pushed into their mounting apertures 30 and held therein by friction. Each locating member 36, 38 includes a stub 42 which fits into its mounting aperture 30. The lanyard 32 is easily removed from the mounting portions 8 via one or both of the locating members 36, 38 to facilitate use of a tool 4 when the tool 4 is on the apparatus 2 or is removed from the apparatus 2. The lanyard 32 is also able easily to accommodate any number of the tools 4 required by a user for the apparatus 2. The mounting means, for example the lanyard 32, may at least partially shield the mounting magnets 10, thereby reducing or avoiding the mounting magnets 10 attracting unwanted articles.

FIG. 10 shows an alternative lanyard 44. The lanyard 44 has a lanyard strip 46 with a male connecting member 48 which fits into a female connecting member 50. The lanyard strip 46 passes through all of the mounting apertures 30 in the tools 4 of the apparatus 2.

FIG. 11 shows how the tools 4 are able to be separated from each other and stuck to mounting means in the form of a magnetic of metallic strip 52. The strip 52 may be secured to a wall, for example in a garage or a van.

FIGS. 12 and 13 show a cover 54 which may be used as a mounting means by which the tools are held together. More specifically, the cover comprises a strip body portion 56 and an elasticated band 58. The elasticated band 58 may be constructed as a single band, or in two parts which are separated at each of their ends by the width of the strip body portion 56. As shown in FIGS. 12 and 13, the upper ends of the strip body portion 56 are provided with mechanical holding means 60 which comprises a push fit arrangement comprising a male member 62 on a first part 64 of the mechanical holding means 60, and a male member 66 on a second part 68 of the mechanical holding means 60. As best seen from FIG. 13, the male members 62, 66 extend into an aperture 70 in at least the outermost two tools 4. Longer male members 62, 66 may extend into the apertures 70 of inner tools 4 sandwiched between the outermost tools 4. Because the strip body portion 56 is relatively long and flexible as compared with the tools 4, the strip body portion 56 is of a length able to accommodate varying numbers of the tools 4 and thus varying thicknesses of the combined tools 4. The elasticated band 58 ensures that the strip body portion 56 is always biased into contact with the outermost two tools 4. The construction shown in FIGS. 12 and 13 may be cheaper to manufacture than the apparatus of the present invention where the tools 4 are held in position by the mounting magnets 10.

It is to be appreciated that the embodiments of the invention described above with reference to the accompanying drawings have been given by way of example only and that modifications may be effected. Thus, for example, different types of apparatus 2 with different types of tools 4 may be provided for different specific areas of use, for example different areas of industry such as carpentry and plumbing, or different areas of leisure use such for example as cycling, camping and survival pursuits. Examples of tools 4 are Allen keys, screwdrivers, knives, saws, a chain splitter, spanners, a bottle opener, a can opener, a wax comb for use by surfers, scissors, pliers, a key holder, and a knife sharpener. The apparatus may be produced in various sizes appropriate to the intended use. Individual components shown in the drawings are not limited to use in their drawings and they may be used in other drawings and in all aspects of the invention. The invention also extends to the individual components mentioned and/or shown above, taken singly or in any combination.

1. Apparatus comprising a plurality of different tools, and the tools being such that:
each tool comprises a functional portion configured for performing a task, and a mounting portion by which the tool is mounted to the apparatus;
(ii) the functional portions of the tools are different for performing different tasks;
(iii) the tools are rotatable relative to one another such that the tools are able to be aligned with their functional portions adjacent each other and pointing in the same direction;
(iv) the tools are usable in the apparatus by rotating a required one of the tools out of alignment with the other tools;
(v) the tools are separable from the apparatus; and
(vi) the tools are constructed for use as stand-alone tools whereby, when the tools are removed from the apparatus, they are able to be used to perform their intended task without having to be connected to other tool parts.

2. Apparatus according to claim 1 in which the mounting portions are of the same shape and size, and located in the same relative position on each tool.

3. Apparatus according to claim 1 or claim 2 in which the tools are held together by magnetism, and in which the tools are separable from the apparatus by being slid from the apparatus against the magnetism.

4. Apparatus according to claim 3 in which each tool comprises a mounting magnetic which enables the tools to be held together by the magnetism.

5. Apparatus according to claim 4 in which the mounting magnet is embedded in the tool such as not to increase the thickness of the tool.

6. Apparatus according to claim 5 in which the mounting magnet is embedded in the tool such as to finish flush with at least one of the sides of the tool.

7. Apparatus according to any one of claims 4-6 in which the mounting magnet is positioned in the mounting portion of the tool.

8. Apparatus according to any one of claims 4-7 in which the tools are made of a non-magnetic material, and in which the mounting magnet is provided in the non-magnetic material.

9. Apparatus according to claim 8 in which the non-magnetic material is an austenitic metal.

10. Apparatus according to claim 9 in which the austenitic metal is stainless steel.

11. Apparatus according to any one of claims 4-10 in which the mounting magnet is a neodymium magnet.

12. Apparatus according to any one of the preceding claims in which the mounting magnet also provides the aligning.

13. Apparatus according to claim 1 or claim 2 in which the tools are held together by mechanical holding means.

14. Apparatus according to claim 13 in which the mechanical holding means is a snap fit mechanical holding means, a press fit mechanical holding means, or a push fit mechanical holding means.

15. Apparatus according to any one of the claims 1-11 and including aligning means for providing the aligning.

16. Apparatus according to claim 15 in which the aligning means is an aligning magnet.

17. Apparatus according to claim 16 in which the aligning magnet is embedded in the tool such as not to increase the thickness of the tool.

18. Apparatus according to claim 17 in which the aligning magnetic is embedded in the tool such as to finish flush with at least one of the sides of the tool.

19. Apparatus according to any one of claims 16-18 in which the aligning magnetic is positioned in the functional portion of the tool.

20. Apparatus according to claim 15 in which the aligning means is a mechanical aligning means.

21. Apparatus according to claim 20 in which the mechanical aligning means is a ball and detent arrangement.

22. Apparatus according to claim 20 or claim 21 in which the mechanical aligning means is on the mounting portion of the tool.

23. Apparatus according to any one of the preceding claims in which the tools are configured with flat sides for enabling the tools to be as thin as possible, and thereby to minimise on the overall thickness of the apparatus.

24. Apparatus according to any one of the preceding claims and in which the mounting portions are each provided with a mounting aperture for receiving mounting means for use in mounting the apparatus.

25. Apparatus according to claim 24 and including the mounting means.

26. Apparatus according to claim 25 in which the mounting means is a lanyard.

27. Apparatus according to any one of the preceding claims and including a cover for the apparatus.

28. Apparatus according to claim 27 in which the cover is a non-magnetic cover.

29. Apparatus according to any one of the preceding claims and including a holder for holding the apparatus on a wall with the tools being separated from each other, the holder being formed of a material which enables the tools to adhere to the holder by magnetism.

30. Apparatus according to claim 29 in which the holder is a magnetic strip.

31. Apparatus according to any one of the preceding claims and including at least one tool body, wherein the tool body comprises a first end by which the tool body is mounted to the apparatus and a second end which is configured for releasably receiving a tool head for performing a task, whereby the second end is able to receive different tool heads for performing different tasks.
